(19) United States
(12) Patent Application Publication
(10) Pub. No.: US 2007/0001431 A1
(43) Pub. Date: Jan. 4, 2007

(54) Portable and adjustable trailer assembly

(76) Inventor: Raymond Fiorini, Oak Park, IL (US)

Correspondence Address: Raymond Fiorini c/o, Suite 202, 6 South Main Street, Washington, PA, 15301, US

(21) Appl. No.: 11/173,483

(22) Filed: Jul. 1, 2005

(51) Int. Cl. B62B 5/00

(52) U.S. Cl. 280/656

(57) ABSTRACT

Disclosed is a portable and adjustable trailer assembly that allows for easy assembling and de-assembling, foldability, portability, requiring small storage space, multi-functional utility, retrofittable to various vehicles, and at the same time light weight and cost effective. It comprises a frame assembly having a frame portion with front and rear ends, pivotally and hingedly coupled at its rear end to a first end of a platform portion, a second end of the platform portion coupled to a rear beam, the portions being releaseably locked with each other and folds out to configure a lateral plane when in operation, a wheel assembly mechanically coupled to the platform portion at its underneath; and a detachable and lockable draw bar assembly having first and second ends, mechanically coupled to the frame assembly at the first end and having means to connect to a tow vehicle at the second end.

### FIELD OF THE INVENTION

The present invention relates to wheel trailers and more particularly relates to a portable and adjustable trailer assembly with multifunction removable drawbars that can be easily assembled and de-assembled to a foldable format to be transported with comfort.

### BACKGROUND OF THE INVENTION

Trailers of the type having a platform surface, generally has at least one pair of wheels with, an axle and suspension, and the wheels are commonly used for commercial and domestic transportation purposes to carry a wide variety of goods; from one place to another, and typically pulled behind a car, truck, van, motorcycle or the like. Most often trailers are rented or are purchased outright. There are several problems associated with renting or owning a trailer. If the trailer is rented, one must first drive to the rental agency with the towing vehicle, upon which time the empty trailer will be attached to the towing vehicle. One will then drive the towing vehicle either home or to the destination of where one is picking up the items to be moved. The first problem is that one is towing an empty trailer which is hard to drive in traffic as it is low in height and not easily visible. Since it is not loaded, it is light and tends to hop and jump around, especially on rough roads or when hitting a hole or bump. This is a dangerous situation as one can lose control of the trailer resulting in a possible accident involving the trailer and the tow vehicle.

Once again after the item is delivered the empty trailer has to be returned to the rental agency. If the trailer is owned, one has to again return home or go to the place to pickup the item with an empty trailer, entailing an additional problem of its storage after use. In a house the garage ideally would serve as a storage place for most large trailers as storing the trailer outside would invite objections from communities. It has been observed that most people already have their garage full of lawn equipment, snow blowers, lawnmowers etc. and to store a trailer might be difficult, if not impossible. The normal trailer is a single unit, and is usually just a flat bed.

Many attempts have been made to address the above-mentioned issues relating to vehicle trailers, and to develop a trailer assembly that meet the requirements of portability, adaptability, retrofittability and transportability.

US Patent Publication No. 20030102655 discloses a folding with pivotally connected front, main and rear sections movable from an unfolded condition to a folded condition, in which the rear section pivots 270 degrees to lie atop the main section, and the front section pivots 90 degrees to nest within the main section. This provides a folded compact arrangement approximately 48″ by 80.″ When unfolded, the trailer produces an inside dimension of approximately 60″ by 96,″ enabled by the front section thin walls that are interiorly nearly as wide as the main and rear sections. An extensible handle facilitates folding and unfolding the rear section. This patent is configurationally different from the present invention and does not address the above-cited issues in an effective manner.

US Patent No. 20050093273 discloses a trailer assembly including a bed sub-assembly having a plurality of sections movably coupled to one another for permitting movement between an extended configuration and a folded configuration. In the folded configuration, the plurality of sections collectively form a bottom surface, an upper surface, and surrounding side walls of an enclosable compartment, at least one of the sections having an access member movable between an open position for permitting access to the compartment and a closed position for enclosing the compartment as the sections are maintained in the folded configuration. The trailer assembly optionally may include a wheel subassembly and drawbar, which may be freely and independently rotatable relative to one another and the bed sub-assembly. The configurational aspects of the trailer assembly with regard to the bed assembly, the optional features of wheel assembly and the draw bar does not address the requirement of a portable trailer assembly for meeting the space constraints and easy transportability.

The features of the aforecited prior art disclose a complex design and structural indices that hinder their performance in meeting the above-mentioned requirements. The prior arts does not provide a configuration that has simple structural indices for reliable operation i.e. can be easily assembled and de-assembled, can be easily folded and is portable enough to be carried and stored in a small space, multi-functional, retrofittable at the same time light weight and affordable too. Therefore, the present scenario is punctuated by an emerging need for a multipurpose, portable and adjustable trailer assembly that addresses these issues with effectiveness, ease and comfort.

### SUMMARY OF THE INVENTION

In view of the foregoing disadvantages inherent in the above-mentioned prior arts, the general purpose of the present invention is to provide an improved combination of convenience and utility, to include all the advantages of the prior arts, and to overcome the abovementioned disadvantages/drawbacks of the prior art.

It is therefore, a principal aspect of the present invention to provide a portable and adjustable trailer assembly that allows for easy assembling and de-assembling, foldability, portable enough to be carried and stored in a small space, multi-functional utility, retrofittable to various vehicles and at the same time light weight and affordable.

It is yet another aspect of the present invention to provide a portable and adjustable trailer assembly which comprises a frame portion and a platform portion releaseably lockable with each other and configuring a frame assembly thereof, a wheel assembly mechanically coupled to the platform portion at its underneath and a detachable and lockable draw bar assembly coupled to the frame assembly and having means to connect to a tow vehicle. The portable and adjustable trailer assembly is configured to be folded into the frame assembly and enables easy storage and transportation.

In yet another aspect the present invention provides for a portable and adjustable trailer assembly comprises a frame assembly having a frame portion with front and rear ends, pivotally and hingedly coupled at its rear end to a first end of a platform portion, the second end of the platform portion coupled to a rear beam, the portions being releaseably locked with each other and folds out to configure a lateral plane when in operation, a wheel assembly mechanically coupled to the platform portion at its underneath; and a detachable and lockable draw bar assembly having first and second ends, mechanically coupled to the frame assembly at the first end having means to connect to a tow vehicle at the second end.

In yet another aspect the present invention provides for a portable and adjustable trailer assembly wherein the means for coupling the detachable and lockable draw bar assembly to the frame assembly may include a box channel underneath the frame assembly, the channel extending completely underneath the frame portion and partially underneath the platform portion. The box channel further has means for coupling the detachable and lockable draw bar assembly to the frame assembly.

In yet another aspect the present invention provides for a method of operating a portable and adjustable trailer assembly having a frame assembly configuring a frame and platform portions with a box channel extending underneath therethrough, a wheel assembly with a pair of wheels, a detachable and lockable draw bar assembly with a draw bar and a chain having a pin, the method comprises keeping the portable and adjustable trailer assembly in an upright position, placing the platform portion on the ground and pushing a handle to outside of the frame portion, pushing a locking mechanism on each side of the frame portion enabling the frame portion to open up about 90 degrees on hinges connected to the platform portion, pulling completely slide bolts with pins on each side of the wheel assembly, pulling up one wheel and pushing the pin back in, repeating the same for the second wheel, configuring a draw bar with a welded bar, holding the draw bar upside down and pushing it into the box channel underneath the frame assembly until it gets locked in the box channel, configuring a two finger clamp on the frame portion and pushing the welded bar in the box channel until the welded bar fits into the two finger clamp, configuring a guide hole in the center of the box channel and inserting the chain pin into the guide hole and locking the same, picking up the portable and adjustable trailer assembly with the draw bar on the rear and tilting the assembly until the wheels touch the ground and coupling the portable and adjustable trailer assembly to a tow vehicle for transportation.

These together with other aspects of the present invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the portable and adjustable trailer assembly 10 in the fully extendable position, according to an exemplary embodiment of the present invention;

FIG. 2 is a pictorial view of the portable and adjustable trailer assembly 10 in a partly folded position, according to an exemplary embodiment of the present invention.

Like reference numerals refer to like parts throughout the several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular portable and adjustable trailer assembly shown and described, but rather the principles of the present invention can be used with a variety of portable and adjustable trailer assembly configurations and structural arrangements. It is understood that various omissions, substitutions of equivalents are contemplated as circumstances may suggest or render expedient, but is intended to cover the application or implementation without departing from the spirit or scope of the claims of the present invention.

The present invention provides a multipurpose trailer assembly, and more specifically, a portable and adjustable trailer assembly, for meeting the requirements of retrofittability, adaptability, portability, transportability, light weight trailer assembly. The present invention further addresses these work requirements thereby serving the commercial viability by providing a cost effective trailer assembly and overcomes all the existing drawbacks.

The present invention provides for a portable and adjustable trailer assembly having a detachable and lockable draw bar assembly along with other assemblies addressing the need of retrofittability to serve multipurpose functions of a trailer assembly in quick, easy, and effective manner and eliminating storage space constraint issues.

The best mode for carrying out the invention is presented in terms of its exemplary embodiments, herein depicted in the enclosed figures.

The present invention describes a portable and adjustable trailer assembly 10 complete having a frame assembly 20 with a frame portion 30 and a platform portion 40, a wheel assembly 50, a detachable and lockable draw bar assembly 70, and means to connect to a tow vehicle's electrical system (not shown).

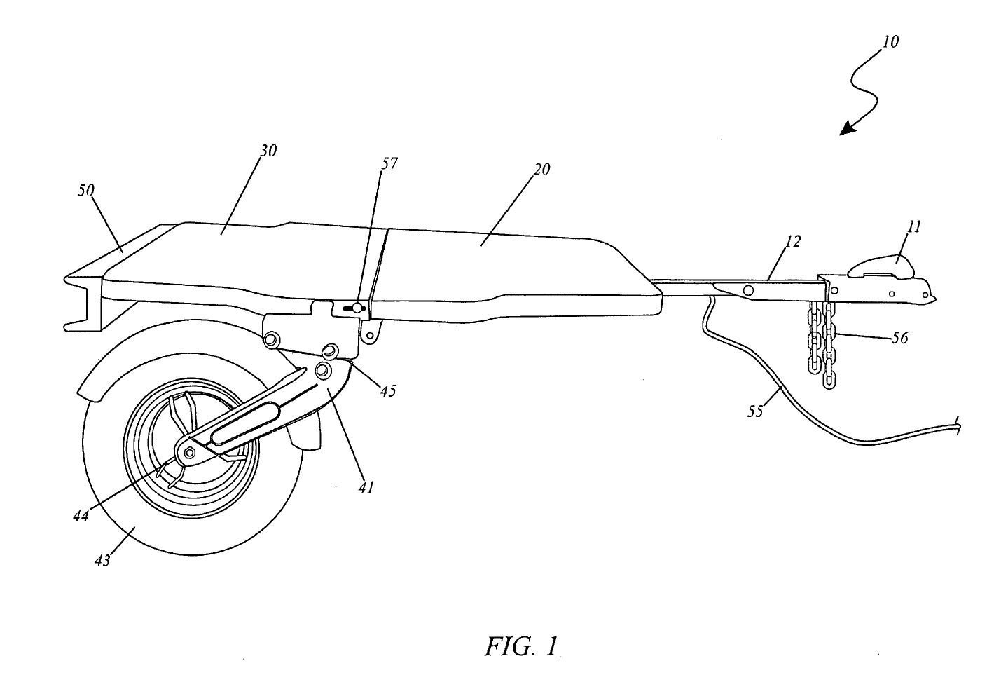

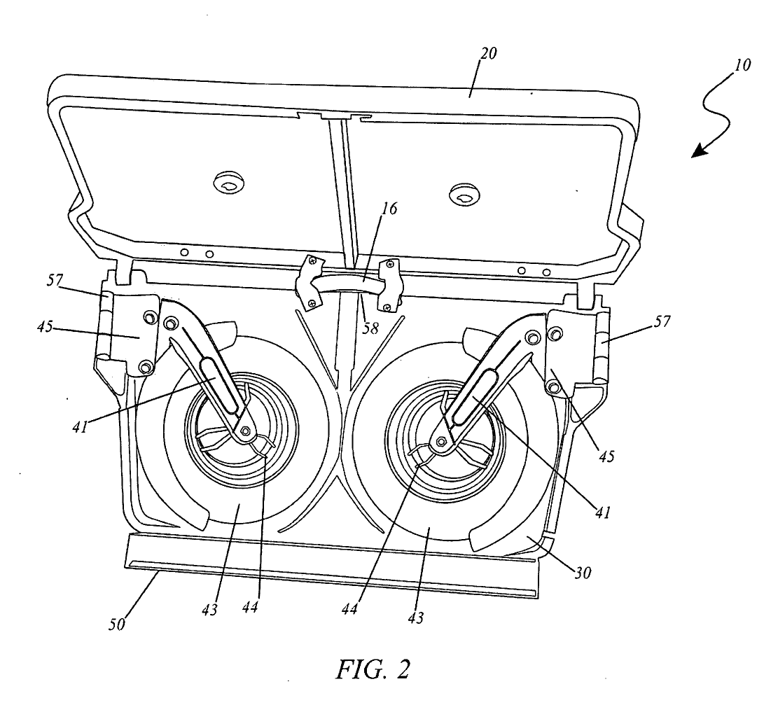

Referring now to FIGS. 1 and 2, the frame and platform sections comprise a light weight, durable, and sturdy fabrication into two separate halves frame portion 30, and platform section 40 pivotally or hingedly connected to each other and configure a lateral plane when in open horizontal condition. Both portions 30, 40 are releaseably locked to each other, and fold out to match the same lateral plane using hinges 34 when in operation as a trailer. The frame portion has a front end 31 and a rear end 32. The platform portion has a first end 42 and a second end 44. The frame portion 30 is connected at its rear end 32 to the first end 42 of the platform portion 40.

The frame portion and the platform portion has means for additional embodiments to have side and intermediate walls (not shown) formed with or attachable thereto to provide means for carrying or supporting items within a box-like structure. Also, means (not shown) are provided to attach a removable and lockable canopy frame and cover or similar device to protect the hauled items and platform surface from inclement weather or other environmental incidents.

The wheel assembly 50 comprises tires and/or wheels, and referred to in this document as wheels 54, fenders 56, and a wheel suspension 52 in band or ring form and made up of rubber is contained within the wheel assembly proper 50. The wheel assembly 50 is secured to the underneath surface of platform portion 40 of the portable and adjustable trailer assembly 10 and configured in such as a way as to fit inside the frame and platform portion 30, 40 when in the folded configuration. When extended via a wheel locking mechanism 62, the wheel assembly 50 extends laterally with respect to the platform portion 40. The locking mechanism 62 is re-engaged when the platform portion 40 and wheel assembly 50 are both fully extended to provide extra durability and sturdiness during use as a trailer. The wheels 54 may be attached to the suspension 52 via a propeller spoke 58 as seen in FIG. 1 and have heavy-duty tires for use on uneven ground and at elevated speeds. The wheel assembly 50 may be configured to add suspension bands supplied for the portable and adjustable trailer assembly 10 to support heavier loads.

A detachable and lockable, draw bar assembly 70 having a first end 72 and second end 74 is provided with the portable and adjustable trailer assembly 10 of the present invention and the detachable and lockable draw bar assembly 70 is also foldable. The detachable and lockable, draw bar assembly 70 is for inserted into a box channel 33 formed as part of or attached thereto the underneath surface of the platform portion that in turn locks into place both frame and platform portion 30, 40, and provides additional security and forces both frame and platform portion 30, 40 to lie in a flat horizontal plane, thereby eliminating any lateral sway during operation. While the portable and adjustable trailer assembly 10 is still in the foldable position, a draw bar handle 82 is provided allowing it to be easily transported. The removable, lockable, and foldable draw bar assembly 70 comprises of a draw bar 76 secured via a locking pin for adjustable connection to the frame 30, a separate tilting pin is also provided for the draw bar assembly 70 on the opposite side of the tilting pin is a release lever which must be pulled to release the tilting pin, which allows the trailer to tilt backward and enables the user to easily load items on said trailer.

The draw bar 76 has a standard ball hitch configuration (not shown) and a handle operated locking means to secure the draw bar 76 to the bar of a vehicle's hitch assembly. The draw bar 76 can also assist the user in lifting and pivoting for attachment of the trailer to a tow vehicle. A safety chain 80 as per standard the U.S. Department of Transportation specifications for attachment to the tow hitch (not shown) is provided on the draw bar 76 on either side near the draw bar handle 82. Additionally, the draw bar 76 is equipped with waterproof vehicle electrical connectors 78 to provide the portable and adjustable trailer assembly 10 with electricity to power any number or configurations of safety lights, turn signals, or any other typical lighting. An example of such lighting is provided with the present invention and comprise lights mounted within a hollow beam at the rear of the platform portion 40.

Alternate embodiments of the removable, lockable, and foldable draw bar assembly include, but are not limited to: an extendable folding draw bar assembly for carrying a plurality of bulky devices, such as bicycles, and a curved draw bar for use with a motorcycle as the tow vehicle. Additional embodiments and accessories for the present invention include, but not limited to: covering means including a tarpaulin cover; frame assembly; and, handle bar and wheel configuration to convert to a hand cart configuration. Waterproof lights are also provided if the portable and adjustable trailer assembly are desired to be lowered into the water, such as lowering or raising a boat to a launching pad. Attachable fenders covering the foldable wheels are also envisioned as an additional accessory for protection of the entire device from dirt or debris during travel.

Operation of the Preferred Embodiment

The exemplary embodiment of the present invention is designed to be used by the common consumer with little or no special skills and minimal experience and training necessary.

When the portable and adjustable trailer assembly 10 is first procured; it may be in the folded configuration, a partial folded condition is shown in FIG. 2 in its proper foldable storage position, most likely the trunk of the vehicle to which it will be attached to. Once removed from it storage position, the portable and adjustable trailer assembly 10 is placed on the ground with the taillight side of the platform 40 contacting the ground and with the handle 36 clearing the frame portion 30. The locking mechanism on either side can then be pushed in to allow the frame portion 30 member to open up on its hinges. Open the frame portion 30 to 90 degrees. Then, the pins in the slide bolts located on each side near the wheel suspension 52 must be fully extended. One wheel 54 to be pulled up and the bolt is to be pushed back. The same to be repeated for the other wheel too so as to fully extend the wheel assembly 50; the pins must be pushed back in and the platform portion 40 is lowered in order to lock the wheel assembly 50 back into place.

The frame portion is laid open thus locking the bolt in place. With the draw bar 76 in the reverse position, it must be pushed into the box channel 33 in the center of the portable and adjustable trailer assembly 10. During the previous action, care must be taken to ensure that the welded bar (not shown) that is attached to the draw bar 76 is forced into the two finger clamp (not shown) located in the front of the portable and adjustable trailer assembly 10. A pin (not shown) at the end of a safety chain 80 is connected to the rear of the box channel 33 which must fully engage the guide hole (not shown) in the center (not shown) of the box channel 33 to secure the draw bar 76 in place; this can be verified by applying a pulling force on the pin (not shown) to ensure that the pin (not shown) is secure. The portable and adjustable trailer assembly 10 may then be tilted forward until the wheels 54 engage the ground, at which point the fully extended portable and adjustable trailer assembly 10 may be transported anywhere.

To attach the portable and adjustable trailer assembly 10 to a tow vehicle's standard ball hitch (not shown), the user must pull up on the draw bar handle 82 to lift the entire portable and adjustable trailer assembly 10 and direct the draw bar 76 onto the ball hitch (not shown). Once the portable and adjustable trailer assembly 10 is on the ball hitch (not shown), the user then presses down on the draw bar handle 82 until it is secured and the safety lock (not shown) is inserted.

A license plate bracket can then be attached by removing the two thumbscrews (not shown), guiding the attached bolts through the apertures provided on the rear beam 46 of the second end 44 of the platform portion 40 of the portable and adjustable trailer assembly 10, and reattaching the thumbscrews. In the center of the rear beam 46 of the platform portion 40 provided are two small holes that houses the rear lights. A wire harness (not shown) is also provided for connection to the tow vehicle's electrical system via a trailer socket. At the front end of wiring attached to the undercarriage female connector (not shown) located within the box channel 33 and with the male connector (not shown) located at the first end 72 of the detachable and lockable draw bar assembly 70.

To fold the portable and adjustable trailer assembly 10, the above directions may be reversed. The portable and adjustable trailer assembly 10 is designed to neatly fit into any standard or conventional trunk space and allow other items to be stored therein. It is light in weight and low in profile to enable ease of use and storage.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications, as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A portable and adjustable trailer assembly comprising a frame portion and a platform portion, said portions releaseably lockable with each other, said frame portion and platform portion configuring a frame assembly thereof, a wheel assembly mechanically coupled to said platform portion at its underneath and a detachable and lockable draw bar assembly coupled to said frame assembly, said detachable and lockable draw bar assembly having means to connect to a tow vehicle, said portable and adjustable trailer assembly is configured to be folded into said frame assembly and enables easy storage and transportation.

2. A portable and adjustable trailer assembly comprising:
a frame assembly having a frame portion with a front and a rear end, said frame portion pivotally and hingedly coupled at said rear end to a first end of a platform portion, a second end of said platform portion coupled to a rear beam, said frame portion and platform portion being releaseably locked with each other and folds out at hinges capable of configuring a lateral plane;
a wheel assembly mechanically coupled to said platform portion at its underneath; and
a detachable and lockable draw bar assembly having first and second ends, said detachable and lockable draw bar mechanically coupled to said frame assembly at said first end having means to connect to a tow vehicle at said second end.

3. The portable and adjustable trailer assembly as claimed in claim 2 wherein said means for coupling said detachable and lockable draw bar assembly to said frame assembly may include a box channel underneath said frame assembly, said channel extending completely underneath said frame portion and partially underneath said platform portion.

4. The portable and adjustable trailer assembly as claimed in claim 3 wherein said box channel further having means for coupling said detachable and lockable draw bar assembly to said frame assembly.

5. The portable and adjustable trailer assembly as claimed in claim 2 wherein said detachable and lockable draw bar assembly has a draw bar having a locking pin for coupling to said box channel of said frame assembly.

6. The portable and adjustable trailer assembly as claimed in claim 2 wherein said detachable and lockable draw bar assembly also has a tilting pin with a release lever that enables said frame assembly to tilt rearwardly about a pivot point defined by said titling pin.

7. The portable and adjustable trailer assembly as claimed in claim 2 wherein said detachable and lockable draw bar assembly further may include a standard ball hitch configuration and a handle operated locking means for securing said detachable and lockable draw bar assembly to a vehicle's hitch assembly.

8. The portable and adjustable trailer assembly as claimed in claim 2 wherein said detachable and lockable draw bar assembly further may include a safety chain for attachment to said vehicle's tow hitch.

9. The portable and adjustable trailer assembly as claimed in claim 2 wherein said detachable and lockable draw bar assembly further may include waterproof electrical connectors for providing electricity to said portable and adjustable trailer assembly.

10. The portable and adjustable trailer assembly as claimed in claim 2 wherein said frame assembly may also include side and intermediate walls formed with or attachable thereto for carrying items.

11. The portable and adjustable trailer assembly as claimed in claim 2 wherein said frame assembly may also include means for attaching a removable and lockable canopy.

12. The portable and adjustable trailer assembly as claimed in claim 2 wherein said wheel assembly further comprises precision sealed bearings thereby eliminating the need for constant adjustment and greasing.

13. The portable and adjustable trailer assembly as claimed in claim 2 wherein said wheel assembly further comprises a pair of wheels with wheel hubs in a three spoke design capable of acting as a propeller to draw air over said bearings thereby keeping said wheels cool even with heavy loads at high speeds.

14. The portable and adjustable trailer assembly as claimed in claim 2 wherein said wheel assembly further comprises a pair of fenders for preventing water, slush or snow from splashing on to said wheel assembly during running.

15. The portable and adjustable trailer assembly as claimed in claim 2 wherein said wheel assembly further comprises a rubber suspension in band or in a ring form to which said wheels are attached through said propeller spokes and are supportive for heavier loads, said suspension eliminates the need of shock absorbers at the same time being foldable.

16. The portable and adjustable trailer assembly as claimed in claim 2 wherein said wheel assembly further comprises a locking pin mechanism for extending the wheel assembly laterally with respect to said frame assembly.

17. A method of operating a portable and adjustable trailer assembly having a frame assembly configuring a frame portion and platform portion with a box channel extending underneath therethrough, a wheel assembly with pair of wheels, a detachable and lockable draw bar assembly with a draw bar and a chain with a pin, the method comprising;
keeping the portable and adjustable trailer assembly in an upright position;
placing the platform portion on the ground and pushing a handle on said frame assembly to outside of said frame portion;
pushing a locking mechanism on each side of said frame portion enabling said frame portion to open up 90 degrees on hinges connected to said platform portion;
pulling completely a slide bolts with pins on each side of said wheel assembly;
pulling up one wheel and pushing said pin back in;
repeating the same for said second wheel;
configuring a draw bar with a welded bar, holding said draw bar upside down and pushing it into said box channel underneath said frame assembly until it gets locked in said box channel;
configuring a two finger clamp on said frame portion and pushing said welded bar in said box channel until said welded bar fits into said two finger clamp;
configuring a guide hole in the center of said box channel and inserting said chain pin into said guide hole and locking the same;
picking up said portable and adjustable trailer assembly with said draw bar on the rear and tilting said assembly until the wheels touch the ground; and
coupling said portable and adjustable trailer assembly to a tow vehicle for transportation.
